(19) United States
(12) Patent Application Publication
(10) Pub. No.: US 2023/0373831 A1
(43) Pub. Date: Nov. 23, 2023

(54) Wastewater Treatment System and Method Using Aerobic Granular Sludge With Immersed Membrane Separation

(71) Applicant: Carollo Engineers, Inc., Costa Mesa, CA (US)

(72) Inventors: John Fraser, Boulder, CO (US); Andrew Gilmore, Tampa, FL (US)

(21) Appl. No.: 18/246,929

(22) PCT Filed: Sep. 27, 2021
(86) PCT No.: PCT/US2021/052164

§ 371 Date: Mar. 28, 2023

Related U.S. Application Data
(60) Provisional application No. 63/084,752, filed on Sep. 29, 2020.

(51) Int. Cl. C02F 3/30; C02F 3/12

(52) U.S. Cl. CPC C02F 3/301; C02F 3/1273; C02F 2305/12

(57) ABSTRACT

A treatment system and method for removal of nutrients and other pollutants to produce a low solid, high quality effluent suitable for discharge or reuse using a combination of aerobic granular sludge (AGS), either in a sequencing batch reactor (SBR) AGS configuration or in a flow through AGS configuration, in combination with immersed/submerged membranes commonly referred to as membrane bio-reactor (MBR) wastewater treatment processes, systems, and methods.

### CROSS REFERENCE TO RELATED APPLICATIONS

This application is the United States national phase of International Application No. PCT/US21/52164 filed Sep. 27, 2021, and claims priority to U.S. Provisional Patent Application No. 63/084,752, entitled “Wastewater Treatment System and Method Using Aerobic Granular Sludge With Immersed Membrane Separation,” filed Sep. 29, 2020, the entire contents of which are herein incorporated by reference.

### BACKGROUND

### Technical Field

The present disclosure relates to wastewater treatment. More particularly, it relates to a treatment system and method for removal of nutrients and other pollutants to produce a low solid, high quality effluent suitable for discharge or reuse using a combination of aerobic granular sludge (AGS), either in a sequencing batch reactor (SBR) AGS configuration or in a flow through AGS configuration, in combination with immersed/submerged membranes commonly referred to as membrane bio-reactor (MBR) wastewater treatment processes, systems, and methods.

### Technical Description

Aerobic granular sludge (AGS), also known as granular activated sludge (GAS), and sometimes included as a subset of ballasted activated sludge (BAS) is a wastewater treatment process for the removal of carbon, suspended solids, nitrogen, phosphorus, and other pollutants and trace contaminants from wastewater. An AGS process encourages the growth of spherical and dense granules of activated sludge biomass. AGS is formed through the creation of certain environmental and physical conditions within the reactor. The required physical and environmental conditions cause cell mass within the reactor to agglomerate around dense spherical granules naturally forming in symbiotic layering of selective bio populations to promote efficient biological conversion of pollutants. The granules exhibit a dense and highly spherical shape which promotes rapid gravity settling and a highly concentrated mixed liquor suspended solids (MLSS) biomass typically between 2 and 5 times higher than conventional activated sludge (CAS) and biological nutrient removal (BNR) processes. AGS treatment results in significantly reduced bio-reactor volume and footprint compared to CAS or BNR due to the highly concentrated biomass mixed liquor. AGS systems may present certain limitations related to higher effluent solids concentrations not directly suitable for reuse without further downstream treatment to remove effluent solids.

Membrane bio-reactor (MBR) is a wastewater treatment and separation process for the removal of carbon, suspended solids, nitrogen, phosphorus, and other pollutants and trace contaminants from wastewater. The MBR system includes two process steps, 1) an MBR bio-reactor often configured into multiple anaerobic, anoxic, and aerobic zones to selectively remove certain pollutants, and 2) a membrane separation tank or zone within the bio-reactor where membranes are immersed/submerged (throughout this disclosure the term “immersed” can also mean “submerged” when referring to membranes) in the MLSS from the MBR bio-reactor for liquids/solids separation. The MBR system uses immersed membranes in a highly concentrated MLSS biomass typically between 2 and 5 times higher than conventional activated sludge (CAS) and biological nutrient removal (BNR) processes. Permeate/filtrate (treated effluent) is withdrawn from the mixed liquor through the membrane using vacuum suction or other pumps. MBR produces a low solid, high quality effluent suitable for discharge or reuse. MBR effluent is generally suitable as pretreatment to other Advanced Water Treatment (AWT) processes including but not limited to Reverse Osmosis (RO) to produce ultra-high water quality sometimes suitable for Indirect Potable Reuse (IPR) or Direct Potable Reuse (DPR). MBR treatment results in significantly reduced bio-reactor volume and footprint compared to CAS or BNR due to highly concentrated biomass mixed liquor and the elimination of the secondary clarification and filtration unit processes since the membrane separation aspects of the MBR combine these two functions.

MBR systems typically require a significant amount of scour aeration in the MBR membrane separation tanks to prevent bio fouling of highly concentrated MLSS on the membrane surface. Scour air production is a significant cost associated with MBR systems. Reduction of scour air provides a benefit when compared to conventional MBR. MBR systems require periodic chemical cleaning to remove precipitants and other micro fouling agents and to maintain free flow of permeate through the membrane. Membrane cleaning is a significant cost associated with MBR systems. Membrane flux is a measure of the amount of liquid that can be pulled through the membrane as permeate per unit of membrane surface area at a given negative suction pressure. The membrane flux rate is a function of several factors including but not limited to chemical content of the wastewater, the permeability and properties of the membrane, MLSS concentrations, scour air rates, solids loading, and cleaning frequencies and procedures. MBR systems with higher flux rates and lower cleaning (scour air and chemical) requirements are more cost effective and provide a longer life cycle to replacement. Membrane integrity is a measure of the potential compromises in the membrane surface that may allow unwanted pollutants to pass through the membrane barrier. Membrane integrity is typically increased with the reduction of fouling mitigation measures such as air scour and chemical cleaning, etc. MBR systems with higher membrane integrity improve the confidence for IPR and DPR reuse in which log removal credits through the membrane could be increased to the credits typically achieved in tertiary (clear effluent) membrane applications. Return Activated Sludge (RAS) rates in an MBR system are typically 3 to 5 times the feed flow and significantly higher than CAS. High RAS rates in an MBR system are required to maintain maximum MLSS floc concentrations allowable by the membrane manufacture to prevent fouling and maintain rated flux. MBR systems with reduced RAS rates are more cost effective to construct and to operate and maintain.

MBR production rates during abnormal increased flow periods (not associated with regular diurnal flow patterns), such as wet weather or other excess flow events, are typically limited by short term allowable flux rate increases that do not compromise the membrane integrity. For example, a given immersed membrane in an MBR system may tolerate a 24-hr flux of 1.3 to 1.6 times higher than the average flux. Similarly, a given immersed membrane in an MBR system may tolerate a 1-hr flux of 1.7 to 2.2 times higher than the average flux. However, many wastewater treatment facilities experience excess or wet weather flows greater than the 24-hr or 1 hr maximum allowable MBR flux rates. Therefore, flows in excess of the allowable membrane flux must be equalized and/or treated using a parallel wet weather excess flow treatment system to avoid overloading the membrane. A system that can optimize the maximum flux rate or provide biological treatment of peak flows without going through the membrane and exceeding the peak membrane flux rates is more cost effective.

### SUMMARY

Described is a system and process for the treatment of wastewater. The system uses a combination of aerobic granular sludge (AGS), either in a sequencing batch reactor (SBR) AGS configuration or in a flow through AGS configuration, in combination with immersed/submerged membranes commonly referred to as membrane bio-reactor (MBR) wastewater treatment processes, systems, and methods. The system may also use high-rate heavy solids removal techniques for clarification, settling, and solids separation of a ballasted activated sludge (BAS) process mixed liquor.

In non-limiting embodiments and aspects or aspects, the present disclosure describes a wastewater treatment system that includes: a first adsorption zone that receives a wastewater input and AGS granules; a first unaerated zone, wherein the first unaerated zone is downstream of the first adsorption zone, wherein the first aerated zone is under anaerobic, anoxic, or both anaerobic and anoxic conditions; a first aerated zone, wherein the first aerated zone is downstream of the first unaerated zone, wherein the first aerated zone is under aerobic conditions; a second unaerated zone, wherein the second unaerated zone is downstream of the first aerated zone, wherein the second unaerated zone is under anaerobic, anoxic, or both anaerobic and anoxic conditions; and a second aerated zone, wherein the second aerated zone is downstream of the second unaerated zone, wherein the flow through AGS reactor produces and discharges an AGS mixed liquor; and a membrane bio-reactor unit downstream of the flow through AGS reactor that receives the AGS mixed liquor discharged from the flow through AGS reactor, the membrane bio-reactor unit comprising one or more immersed membranes within a membrane tank, wherein the membrane bio-reactor unit filters the AGS mixed liquor and produces a clarified permeate.

In non-limiting embodiments or aspects, the wastewater treatment system may introduce AGS granules to the wastewater in the first adsorption zone. In non-limiting embodiments or aspects, a ballast material may be introduced to the wastewater in the first adsorption zone. The AGS granules may comprise the ballast material.

In some non-limiting embodiments or aspects, the wastewater treatment may comprise at least one mixing device within at least one of the unaerated zones of the flow through AGS reactor, wherein the at least one mixing device can be turned on or off.

In some non-limiting embodiments or aspects, the wastewater treatment system may comprise at least one aeration device within at least one of the aerated zones of the flow through AGS reactor. In non-limiting embodiments or aspects, the aeration device may be placed outside of the AGS reactor.

In some non-limiting embodiments or aspects, the wastewater treatment system may comprise a selector zone, wherein the selector zone is downstream of the flow through AGS reactor and upstream of the membrane bio-reactor unit, and wherein the selector zone separates the AGS granules and/or ballast material from the AGS mixed liquor. The separated granules and/or ballast material may be reintroduced in the first adsorption zone of the flow through AGS reactor.

In some non-limiting embodiments or aspects, the wastewater treatment system may comprise an excess flow unit, wherein the excess flow unit is downstream of the flow through AGS reactor and separate from the membrane bio-reactor unit, and wherein a portion of the wastewater flows to the excess flow unit.

In some non-limiting embodiments or aspects, the wastewater treatment system may comprise two or more flow through AGS reactors. The two or more reactors may operate in parallel. In some non-limiting embodiments or aspects, the flow through AGS reactor may be a multi-pass flow through reactor.

In some non-limiting embodiments or aspects, the wastewater treatment system may comprise two or more membrane bio-reactor units. The two or more bio-reactor units may operate in parallel. In non-limiting embodiments or aspects, membrane bio-reactor unit of the wastewater treatment system may comprise an aeration system.

In some non-limiting embodiments or aspects, the wastewater treatment system may comprise at least one return activated sludge selector unit that is downstream of the membrane bio-reactor unit, wherein the at least one return activated sludge selector is adapted to separate the AGS granules and/or ballast material from a discharge of the membrane bio-reactor unit. The separated granules and/or ballast material from the at least one return activated sludge selector unit may be reintroduced to the flow through AGS reactor.

In non-limiting embodiments or aspects, the disclosure describes a method of treating wastewater. The method of treating wastewater may include: treating the wastewater in a flow through activated granular sludge (AGS) reactor, comprising: (a) introducing the wastewater and AGS granules to an adsorption zone of the flow through AGS reactor; (b) distributing the wastewater to a first unaerated zone of the flow through AGS reactor, wherein the first unaerated zone is downstream of the adsorption zone, wherein the first unaerated zone is under anaerobic, anoxic, or both anaerobic and anoxic conditions; (c) distributing the wastewater to a first aerated zone of the flow through AGS reactor, wherein the first aerated zone is downstream of the first unaerated zone, wherein the first aerated zone is under aerobic conditions; (d) distributing the wastewater to a second unaerated zone of the flow through AGS reactor, wherein the second unaerated zone is downstream of the first aerated zone, wherein the second unaerated zone is under anaerobic, anoxic, or both anaerobic and anoxic conditions; and (e) distributing the wastewater to a second aerated zone of the flow through AGS reactor, wherein the second aerated zone is downstream of the second unaerated zone, wherein the second aerated zone is under aerated conditions; (f) outputting from the flow through AGS reactor an AGS mixed liquor; and treating the AGS mixed liquor in a membrane bio-reactor unit, comprising: (a) distributing the AGS mixed liquor to the membrane bio-reactor unit, wherein the membrane bio-reactor unit comprises one or more immersed membranes within a membrane tank; and (b) filtering the AGS mixed liquor in the membrane bio-reactor unit to produce a clarified permeate.

In some non-limiting embodiments or aspects, the method of treating wastewater may comprise introducing AGS granules to the wastewater in the first adsorption zone. In non-limiting embodiments or aspects, the method of treating wastewater may comprise introducing ballast material to the wastewater in the first adsorption zone. The AGS granules may comprise the ballast material.

In some non-limiting embodiments or aspects, the method of treating wastewater may comprise mixing the wastewater in the unaerated zones of the flow through AGS reactor. In non-limiting embodiments or aspects, the method of treating wastewater may comprise aerating the aerated zones of the flow through reactor.

In some non-limiting embodiments or aspects, the method of treating wastewater may comprise separating the AGS granules and/or ballast material from the AGs mixed liquor. The separated AGS granules and/or ballast material may be reintroduced to the adsorption zone of the flow through AGS reactor.

In some non-limiting embodiments or aspects, the method of treating wastewater may comprise distributing a portion of the wastewater to an excess flow unit.

In some non-limiting embodiments or aspects, the method of treating wastewater may comprise using two or more flow through AGs reactors. The two or more AGS reactors may operate in parallel, wherein each of the flow through AGS reactors treats the wastewater pursuant to steps (a)-(e) as previously discussed to generate AGs mixed liquor. In non-limiting embodiments or aspects, the flow through AGS reactor may be a multi-pass AGS flow through reactor.

In some non-limiting embodiments or aspects, the method of treating wastewater may include using two or more membrane bio-reactor units. The output of the membrane bio-reactor unit may be subjected to a return activated sludge separation process to recover AGS granules and/or ballast material. The recovered AGS granules and/or ballast material in the return activated sludge separation process may be introduced to the flow through AGS reactor.

Further non-limiting embodiments or aspects will be set forth in the following numbered clauses:

Clause 1: A wastewater treatment system, comprising: a flow through activated granular sludge (AGS) reactor, comprising: a first adsorption zone that receives a wastewater input and AGS granules; a first unaerated zone, wherein the first unaerated zone is downstream of the first adsorption zone, wherein the first unaerated zone is under anaerobic, anoxic, or both anaerobic and anoxic conditions; a first aerated zone, wherein the first aerated zone is downstream of the first unaerated zone, wherein the first aerated zone is under aerobic conditions; a second unaerated zone, wherein the second unaerated zone is downstream of the first aerated zone, wherein the second unaerated zone is under anaerobic, anoxic, or both anaerobic and anoxic conditions; and a second aerated zone, wherein the second aerated zone is downstream of the second unaerated zone, wherein the flow through AGS reactor produces and discharges an AGS mixed liquor; and a membrane bio-reactor unit downstream of the flow through AGS reactor that receives the AGS mixed liquor discharged from the flow through AGS reactor, the membrane bio-reactor unit comprising one or more immersed membranes within a membrane tank, wherein the membrane bio-reactor unit filters the AGS mixed liquor and produces a clarified permeate.

Clause 2: The wastewater treatment system of clause 1, wherein the AGS granules are introduced to the wastewater in the first adsorption zone.

Clause 3: The wastewater treatment system of either of clauses 1 and 2, further comprising at least one mixing device within at least one of the unaerated zones of the flow through AGS reactor, wherein the at least one mixing device can be turned on or off.

Clause 4: The wastewater treatment system of any of clauses 1-3, further comprising at least one aeration device within at least one of the aerated zones of the flow through AGS reactor.

Clause 5: The wastewater treatment system of any of clauses 1-4, wherein a ballast material is introduced to the wastewater in the first adsorption zone.

Clause 6: The wastewater treatment system of any of clauses 1-5, wherein the AGS granules comprise the ballast material.

Clause 7: The wastewater treatment system of any of clauses 1-6, further comprising a selector zone, wherein the selector zone is downstream of the flow through AGS reactor and upstream of the membrane bio-reactor unit, and wherein the selector zone separates the AGS granules and/or ballast material from the AGS mixed liquor.

Clause 8: The wastewater treatment system of any of clauses 1-7, wherein the separated granules and/or ballast material are reintroduced in the first adsorption zone of the flow through AGS reactor.

Clause 9: The wastewater treatment system of any of clauses 1-8, further comprising an excess flow unit, wherein the excess flow unit is downstream of the flow through AGS reactor and separate from the membrane bio-reactor unit, and wherein a portion of the wastewater flows to the excess flow unit.

Clause 10: The wastewater treatment system of any of clauses 1-9, further comprising two or more flow through AGS reactors operating in parallel.

Clause 11: The wastewater treatment system of any of clauses 1-10, wherein the flow through AGS reactor is a multi-pass flow through reactor.

Clause 12: The wastewater treatment system of any of clauses 1-11, wherein the membrane bio-reactor unit comprises an aeration system.

Clause 13: The wastewater treatment system of any of clauses 1-12, further comprising two or more membrane bio-reactor units operating in parallel.

Clause 14: The wastewater treatment system of any of clauses 1-13, further comprising at least one return activated sludge selector unit downstream of the membrane bio-reactor unit, wherein the at least one return activated sludge selector unit is adapted to separate the AGS granules and/or ballast material from a discharge of the membrane bio-reactor unit.

Clause 15: The wastewater treatment system of any of clauses 1-14, wherein the separated granules and/or ballast material from the at least one return activated sludge selector unit is reintroduced to the flow through AGS reactor.

Clause 16: A method of treating wastewater in a wastewater treatment system comprising: treating the wastewater in a flow through activated granular sludge (AGS) reactor, comprising: (a) introducing the wastewater and AGS granules to an adsorption zone of the flow through AGS reactor; (b) subsequent to step (a), distributing the wastewater to a first unaerated zone of the flow through AGS reactor, wherein the first unaerated zone is downstream of the adsorption zone, wherein the first unaerated zone is under anaerobic, anoxic, or both anaerobic and anoxic conditions; (c) subsequent to step (b), distributing the wastewater to a first aerated zone of the flow through AGS reactor, wherein the first aerated zone is downstream of the first unaerated zone, wherein the first aerated zone is under aerobic conditions; (d) subsequent to step (c), distributing the wastewater to a second unaerated zone of the flow through AGS reactor, wherein the second unaerated zone is downstream of the first aerated zone, wherein the second unaerated zone is under anaerobic, anoxic, or both anaerobic and anoxic conditions; and (e) subsequent to step (d), distributing the wastewater to a second aerated zone of the flow through AGS reactor, wherein the second aerated zone is downstream of the second unaerated zone, wherein the second aerated zone is under aerated conditions; (f) outputting from the flow through AGS reactor an AGS mixed liquor; and treating the AGS mixed liquor in a membrane bio-reactor unit, comprising: (a) distributing the AGS mixed liquor to the membrane bio-reactor unit, wherein the membrane bio-reactor unit comprises one or more immersed membranes within a membrane tank; and (b) subsequent to step (a), filtering the AGS mixed liquor in the membrane bio-reactor unit to produce a clarified permeate.

Clause 17: The method of clause 16, wherein the AGS granules are introduced to the wastewater in the adsorption zone.

Clause 18: The method of either of clauses 16 and 17, further comprising mixing the wastewater in the unaerated zones of the flow through AGS reactor.

Clause 19: The method of any of clauses 16-18, further comprising aerating the aerated zones of the flow through reactor.

Clause 20: The method of any of clauses 16-19, further comprising introducing a ballast material to the wastewater in the adsorption zone.

Clause 21: The method of any of clauses 16-20, wherein the AGS granules comprises the ballast material.

Clause 22: The method of any of clauses 16-21, further comprising separating the AGS granules and/or ballast material from the AGS mixed liquor.

Clause 23: The method of any of clauses 16-22, further comprising reintroducing the AGS granules and/or ballast material to the adsorption zone of the flow through AGS reactor.

Clause 24: The method of any of clauses 16-23, further comprising distributing a portion of the wastewater to an excess flow unit.

Clause 25: The method of any of clauses 16-24, wherein the wastewater treatment system comprises two or more flow through AGS reactors operating in parallel, wherein each of the flow through AGS reactors treats the wastewater pursuant to steps (a)-(e) of claim 16 to generate AGS mixed liquor.

Clause 26: The method of any of clauses 16-25, wherein the flow through AGS reactor is a multi-pass AGS flow through reactor.

Clause 27: The method of any of clauses 16-26, further comprising aerating the AGS mixed liquor in the membrane bio-reactor unit.

Clause 28: The method of any of clauses 16-27, wherein the wastewater treatment system comprises two or more membrane bio-reactor units.

Clause 29: The method of any of clauses 16-28, further comprising subjecting an output of the membrane bio-reactor unit to a return activated sludge separation process to recover AGS granules and/or ballast material.

Clause 30: The method of any of clauses 16-29, further comprising introducing the AGS granules and/or ballast material that were recovered in the return activated sludge separation process to the flow through AGS reactor.

These and other features and characteristics of the present disclosure, as well as the methods of operation and functions of the related elements of structures and the combination of parts will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 is a sectional schematic of non-limiting embodiments or aspects of an aerobic granular sludge (AGS) flow through reactor in accordance with certain aspects of the present disclosure;

FIG. 2 is a plan view schematic of non-limiting embodiments or aspects of a three-pass aerobic granular sludge (AGS) flow through reactor in accordance with certain aspects of the present disclosure;

FIGS. 3a and 3b are schematics of non-limiting embodiments or aspects of a membrane bio-reactor (MBR) in accordance with certain aspects of the present disclosure;

FIG. 4 is a schematic of non-limiting embodiments or aspects of a system including an aerobic granular sludge (AGS) sequencing batch reactor (SBR) and membrane bio-reactor (MBR) in accordance with certain aspects of the present disclosure;

FIG. 5 is a schematic of non-limiting embodiments or aspects of a system including an aerobic granular sludge (AGS) flow through reactor with AGS pre-clarification and selection prior to membrane bio-reactor (MBR) in accordance with certain aspects of the present disclosure; and

FIG. 6 is a schematic of non-limiting embodiments or aspects of a system including an aerobic granular (AGS) flow through reactor without AGS pre-clarification and selection prior to membrane bio-reactor (MBR) in accordance with certain aspects of the present disclosure.

### DETAILED DESCRIPTION

For purposes of the description hereinafter, spatial orientation terms shall relate to the embodiment as it is oriented in the drawing figures. However, it is to be understood that the various embodiments of this disclosure may assume alternative variations and step sequences, except where expressly specified to the contrary. It is also to be understood that the specific devices and processes illustrated in the attached drawings, and described in the following specification, are simply exemplary. Hence, specific dimensions and other physical characteristics related to the embodiments disclosed herein are not to be considered as limiting.

As used in the specification, the singular form of “a”, “an”, and “the” include plural referents unless the context clearly dictates otherwise. Additionally, the use of “or” means “and/or” unless specifically stated otherwise, even though “and/or” may be explicitly used in certain instances.

Unless otherwise indicated, all ranges or ratios disclosed herein are to be understood to encompass any and all subranges or sub-ratios subsumed therein. For example, a stated range or ratio of “1 to 10” should be considered to include any and all subranges between (and inclusive of) the minimum value of 1 and the maximum value of 10; that is, all subranges or subratios beginning with a minimum value of 1 or more and ending with a maximum value of 10 or less, such as but not limited to, 1 to 6.1, 3.5 to 7.8, and 5.5 to 10.

As used in the claims or the specification, the language “at least one of X, Y, and Z” means “only X, only Y, or only Z; at least one of X and at least one of Y, at least one of X and at least one of Z, or at least one of Y and at least one of Z; or at least one of X and at least one of Y and at least one of Z.”

All documents, such as but not limited to issued patents and patent applications, referred to herein, and unless otherwise indicated, are to be considered to be “incorporated by reference” in their entirety.

In accordance with certain non-limiting embodiments or aspects, provided is a system and method for treating wastewater using an AGS process combined with an immersed membrane for liquids/solids separation and selection to produce a low solids effluent suitable for discharge or reuse. The AGS process can be configured in either a sequencing batch reactor (SBR) format or in a flow through (e.g., continuous flow) reactor. The system and method can be designed to provide the required environmental and physical conditions that promote and preserve AGS granule formation, and can be combined with either pre-clarified and settled AGS clear supernatant or unsettled AGS mixed liquor introduced to the membrane separation tank. Introduction of pre-clarified and settled AGS clear supernatant or unsettled AGS mixed liquor each have distinct advantages over a typical immersed membrane MBR process operating on a conventional dispersed biomass floc, non-granular and mixed liquor.

The physical and environmental conditions typically required to support AGS include: creating a biomass “feast and famine” environment, exposure of the granules to feed wastewater in a manner that encourages rapid pollutant adsorption, creating appropriate cyclical aerated and unaerated conditions to select for certain biomass and remove certain pollutants, movement of granules within a water column through use of mixers, aeration, or gravity to encourage agglomeration of biomass to the granules and promote sphericity, a biomass selector mechanism which can consist of cyclones, sieves, stacked tray, plate or tube settlers etc. to retain larger heavier particles and granules and selectively waste lighter suspended biomass, and other conditions. The AGS granules can be removed through either a selector or known solid/liquid separation techniques to separate the granules from the liquid component. The lighter suspended biomass can be removed through a known solid/liquid separation technique using gravity clarification, high rate clarification, or membrane separation.

In non-limiting embodiments or aspects, the AGS process can be configured as a SBR. SBRs typically include one or more tanks in parallel that treat wastewater with a series, or sequences, of stages. In a typical AGS process in an SBR, these stages include, not necessarily in this order, a fill stage where the reactor is filled with wastewater sometimes through an upflow distribution network that encourages rapid pollutant adsorption to the granule (creating a feast cycle), multiple sequential react stages that may include aerated and unaerated sequences, where environmental conditions allow for selective pollutant removal (creating a famine cycle) and physical conditions cause the biofilm to agglomerate and segregate in layers around solid granules, a settle stage where the solid granules settle to the bottom of the SBR tank, and a decant stage where the liquid is separated from the solids. The decant stage is sometimes concurrent with the fill stage allowing the influent water to displace treated effluent out of the SBR reactor.

A SBR process that utilizes the concept of AGS is described, for example, in U.S. Pat. No. 7,273,553, assigned to DHV Water BV, the disclosure of which is herein incorporated by reference in its entirety.

In non-limiting embodiments or aspects, rather than the SBR format for the AGS process described above, a flow through AGS reactor can instead be used. The flow through reactor can include a series of reactor zones which recreate the feast and famine environment of the SBR described above. For example, a flow through reactor can be configured to include an adsorption zone for receiving the wastewater to be treated. The adsorption zone can include AGS granules. The reactor can include an unaerated zone downstream of the adsorption zone that is under anaerobic, anoxic, or both anaerobic and anoxic conditions, an aerated zone downstream of the unaerated zone under aerobic conditions, a second unaerated zone downstream of the first aerated zone under anaerobic, anoxic, or both anaerobic and anoxic conditions, and a second aerated zone downstream of the second unaerated zone, wherein the second aerated zone is under aerobic conditions. The flow through reactor could include a final granule selection and pre-clarification zone to retain the granules within the reactor and allow return granules to the initial adsorption zone. The selector zone may incorporate grit removal technology or other high rate separation techniques such as cyclones, tube and plate settlers, etc. The flow through reactor can be configured such that, in operation, the wastewater and AGS granules flow continuously from the first adsorption zone through the first unaerated zone, the first aerated zone, the second unaerated zone, and the second aerated zone. The flow through reactor can be a single pass reactor or it can be a multi-pass reactor that includes a first pass, a second pass downstream of the first pass, and a third pass downstream of the second pass, wherein each of the first pass, the second pass, and the third pass includes an adsorption zone, an unaerated zone downstream of the adsorption zone, and an aerated zone downstream of the unaerated zone such that, in operation, the wastewater and AGS granules flow continuously from the first pass to the second pass and from the second pass to the third pass.

A flow through AGS reactor is described, for example, in PCT Application Publication No. WO 2020/205834, assigned to Carollo Engineers, Inc., the disclosure of which is herein incorporated by reference in its entirety.

A flow through AGS reactor may include a side stream SBR incubator similarly configured to the reactor. The granules from the side stream SBR incubator can be introduced to a CAS biological reactor and then to an MBR reactor. An example incubator is described in U.S. Patent Application Publication No. 2018/0339925, assigned to Organo Corporation, the disclosure of which is herein incorporated by reference in its entirety.

In addition, or as an alternative, a flow through AGS reactor may include a side stream flow through incubator similarly configured to the reactor. The granules from the side stream flow through incubator can be introduced to a CAS biological reactor and then to an MBR reactor. An example incubator is described in U.S. Patent Application Publication No. 2020/0002201, assigned to AECOM, the disclosure of which is herein incorporated by reference in its entirety.

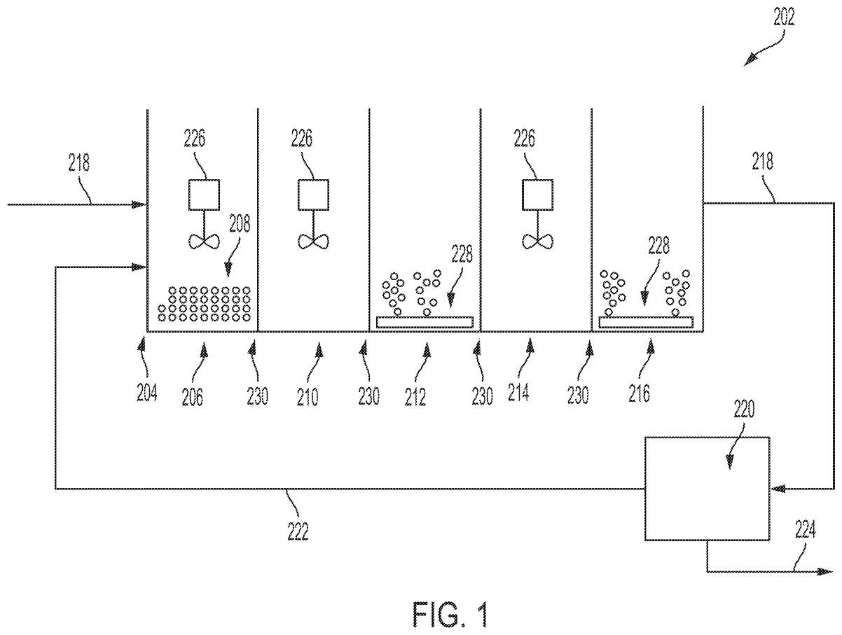

Referring to FIG. 1, shown is a sectional schematic of non-limiting embodiments or aspects of a single pass, flow through aerobic granular sludge (AGS) system 202 for treating wastewater incorporated into an existing or a new flow through reactor 204. A first adsorption zone 206 of the flow through reactor 204 of the system 202 can include AGS granules 208. The AGS granules 208 can be returned to the first adsorption zone 206 from a selector zone 220 and exposed to wastewater in a manner that promotes rapid adsorption of pollutants, including nutrients and soluble BOD uptake into the AGS granules 208. A mixing device 226 can be turned on or off to suspend the AGS granules 208 in the wastewater or allow the granules to settle at the bottom of the first adsorption zone 206 of the flow through reactor 204 for improved adsorption. Wastewater having a high pollutant, nutrient, and/or BOD content can be introduced into at least the first adsorption zone 206 through a wastewater distribution system 218. The wastewater distribution system 218 may include an inlet pipe, a piping distribution network, an underdrain system at the bottom of the adsorption zone, a step feed channel, or other wastewater feed apparatuses or methods that promote rapid pollutant adsorption into the AGS granules 208. As the wastewater comes into contact with the AGS granules 208, pollutants are adsorbed into the AGS granules 208. This represents the “feast” stage of the required “feast and famine” cycle referenced above. Once BOD is adsorbed, it begins to penetrate through the AGS granules 208 where it is converted and used by the biomass in the different layers of the AGS granules 208. Each layer of the AGS granules 208 can change the character of the nutrients and make the nutrients usable as a substrate for the next layer of biomass that is deeper in the AGS granules 208. This process continues deeper and deeper into the AGS granules 208, starting with aerobic conditions on the outside of the AGS granules 208 and proceeding into anoxic and then anaerobic conditions as penetration into the AGS granules 208 continues.

The wastewater distribution system 218 can create even distribution of raw wastewater through the settled AGS granules 208. The even distribution of raw wastewater can be accomplished by using an inlet pipe, a piping distribution network, an underdrain system at the bottom of the first adsorption zone 206, a step feed channel, or other wastewater feed apparatuses or methods. The inlet pipe, piping distribution network, underdrain system at the bottom of the first adsorption zone 206, or step feed channel can receive the influent wastewater from a wastewater feed pipe or channel and can create an even distribution of wastewater at the bottom of the reactor evenly distributed across the entire bottom surface of the reactor, thereby creating complete contact of wastewater with the AGS granules 208. In a typical SBR, this adsorption cycle is generally unaerated and the mixing and aeration is turned off so that granules are settled to the bottom of the reactor. However, in some non-limiting embodiments or aspects as shown in FIG. 1, a mixing device 226 within the first adsorption zone 206 can be turned off and on periodically. Operating the mixing device 226 during the adsorption period allows the granules and wastewater in the first adsorption zone 206 to move on to, or be distributed to, the next reactor zone, which in some non-limiting embodiments or aspects are shown as a first unaerated zone 210, and subsequently continuously flow through the entire flow through reactor 204 of the system 202. In some non-limiting embodiments or aspects, a mixing device 226 within the first unaerated zone 210 can be turned off and on periodically. Flow of wastewater and granules between zones can occur when, for example, the wastewater and granules flow underneath, around, or over the top of the baffle walls 230 separating each zone, or through openings in the baffle walls 230.

As mentioned above, some non-limiting embodiments or aspects of the flow through reactor 204 of the system 202 shown in FIG. 1 are intended to provide the required physical and environmental conditions for development and maintenance of AGS granules 208 similar to the cycles of an SBR. With reference to the non-limiting embodiments or aspects of FIG. 1, the first adsorption zone 206 is followed by a first unaerated zone 210 that is located downstream of the first adsorption zone 206. A first aerated zone 212 is located downstream of the first unaerated zone 210. A second unaerated zone 214 is located downstream of the first aerated zone 212. A second aerated zone 216 is located downstream of the second unaerated zone 214. The first unaerated zone 210 and the second unaerated zone 214 are under anaerobic, anoxic, or both anaerobic and anoxic conditions. The first unaerated zone 210 and the second unaerated zone 214 can include a mixing device 226 that can be turned off and on periodically. The first aerated zone 212 and the second aerated zone 216 are under aerobic conditions. The sequence of the first adsorption zone 206, the first unaerated zone 210, the first aerated zone 212, the second unaerated zone 214, and the second aerated zone 216 depletes the substrate creating the “famine” stage of the “feast and famine” cycle referenced above. The sizes of each zone can be modified and refined to allow for appropriate cycle time under each of the required physical and environmental conditions. For example, the second aerated zone 216 at the end of the flow through reactor 204 can be larger to create a longer aerated cycle time to ensure that the remaining substrate is used by the bacteria causing the bacteria to enter the “famine” stage due to the absence of remaining substrate to consume. Causing the bacteria to enter the “famine” stage helps promote AGS granules 208 with specialized layers of bacteria. In addition, while FIG. 1 illustrates two aerated zones and two unaerated zones, the reactor 204 may include more than two aerated zones and more than two unaerated zones, such as three of each, four of each, or more than four of each zone, where the unaerated and aerated zones may alternate. The reactor 204 may additionally include more than one adsorption zone.

As mentioned above, the first adsorption zone 206 can be outfitted with a mixing device 226. The type of mixing device 226 is not limited to any particular embodiments or aspects. Possible mixing device 226 configurations include mechanical bladed mixers, impeller mixers, hydraulic mixers, large bubble mixers, or any other form of mixer that is typically used for mixing of zones in a BNR aeration basin. The first unaerated zone 210 and the second unaerated zone 214 can also include a mixing device 226, and each mixing device 226 can suspend the AGS granules 208 within the wastewater so the AGS granules 208 can flow to the next zone and can create an up and down movement within the water column of the zone wherein the AGS granules 208 can attract and retain floc and build the dense and highly spherical shape.

The flow through reactor 204 of the system 202 can include a first aerated zone 212 and second aerated zone 216. The first aerated zone 212 and the second aerated zone 216 can be configured like standard aerobic zones that would be found in a typical activated sludge or BNR system. The first aerated zoned 212 and the second aerated zone 216 can use any known type of aeration device 228 commonly used in those systems, including, for example, a sparger aerator, a coarse bubble aeration system, a fine bubble aeration system, or a surface aeration system. Each aeration device 228 may be capable of cycling on and off or it may run continuously. There may be a benefit in cycling the air on and off to create additional transient anoxia conditions. The aeration device 228 may be placed outside of the flow through reactor 204, and air may be fed through a feed valve into the aerated zones.

The flow through reactor 204 of the system 202 can include a selector zone 220, which could utilize a high-rate heavy solids removal and/or high clarification (such as through the use of Headcells), or other grit or solids removal system(s), positioned downstream of the second aerated zone 216 that can allow heavy particles to settle out and lighter particles to continue on downstream either to an existing or new clarifier (e.g., circular, rectangular, high rate, or other type of clarifier) or filtration system (e.g., cloth filter, multimedia filter, membrane, or other type of filter). Other grit removal systems include stacked tray grit removal systems, aerated grit removal units, vortex type grit removal units, plate or tube settler solids removal units, or cyclone type grit removal units. In some non-limiting embodiments or aspects, heavier granules can be recovered and passed through a return AGS pumping system 222, where they can be added back into the first adsorption zone 206. AGS granules can be returned to the first adsorption zone 206 by, for example, dispensing the AGS granules 208 into the inlet wastewater stream that is fed into first adsorption zone 206 or AGS granules 208 can be returned to the first adsorption zone 206 by feeding AGS granules 208 from the return AGS pumping system 222 directly into first adsorption zone 206. The recovery process can involve allowing the heavier granules to drop onto trays, transferring them to a center column, and then pumping them out of the underflow portion of the center column through the return AGS pumping system 222. The selector zone 220 can be configured to allow lighter biomass floc to pass through the selector zone 220 and out of the flow through reactor 204. For example, the liquid and lighter biomass floc that has not been incorporated into a granule may be removed from the reactor, whereas the heavier more dense solids, such as AGS granules 208, can be retained in the reactor. Lighter floc biomass particles, such as particles that do not tend to agglomerate, are washed out of the reactor and can flow to existing or new downstream liquids/solids separation processes such as conventional secondary or final clarifiers, high rate clarifiers, grit removal technologies, filtration systems including for example, media filtration, cloth filtration, or membrane filtration through treated wastewater stream 224, while AGS granules 208 can be retained in the reactor and returned to the initial or subsequent adsorption zones. Alternatively, selector zone 220 can separate lighter biomass floc from the liquid phase so that treated wastewater stream 224 contains only limited amounts of the lighter biomass floc.

The flow through reactor 204 of the system 202 can include baffle walls 230 separating each zone. The baffle walls 230 can be constructed of any suitable material and are commonly concrete, wood, fiberglass, steel, or fabric curtains, etc. In addition, alternating aerated and unaerated zones can also be created without hard baffle walls by alternating zones with aeration grids and without aeration grids, or by turning aeration on and off in alternating aeration grids within a single zone. In FIG. 1, the flow through reactor 204 of the system 202 includes four baffle walls 230 separating each zone. The number, placement, and orientation of baffle walls 230 are not limited to those shown in some non-limiting embodiments or aspects and fewer or more baffle walls could be utilized in the flow through reactor 204 of the system 202. The addition of baffle walls 230 could allow for more zones to provide additional aerated and unaerated sequences.

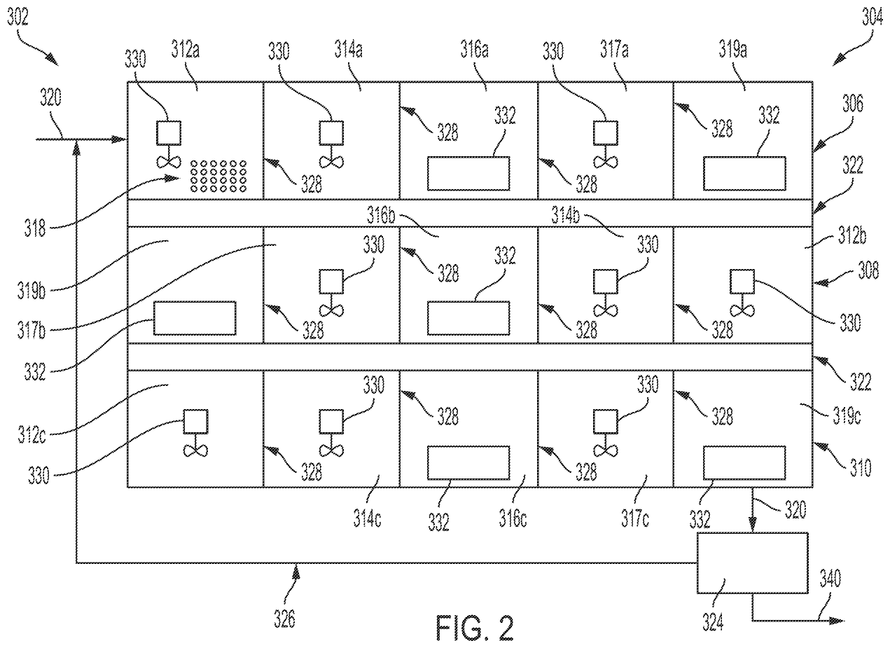

Referring to FIG. 2, shown is a plan view schematic of non-limiting embodiments or aspects of a multi-pass flow through AGS system 302 for treating wastewater incorporated into an existing or a new multi-pass flow through reactor 304. The system and method for treating wastewater of the multi-pass flow through reactor 304 of the system 302 can be incorporated into other multiple pass aeration basin configurations. In a first pass 306, the multi-pass flow through reactor 304 of the system 302 includes an adsorption zone 312a, a first unaerated zone 314a downstream of the adsorption zone 312a, a first aerated zone 316a downstream of the first unaerated zone 314a, a second unaerated zone 317a downstream of the first aerated zone 316a, and a second aerated zone 319a downstream of the second unaerated zone 317a. In a second pass 308, the multi-pass flow through reactor 304 of the system 302 also includes an adsorption zone 312b, a first unaerated zone 314b downstream of the adsorption zone 312b, a first aerated zone 316b downstream of the first unaerated zone 314b, a second unaerated zone 317b downstream of the first aerated zone 316b, and a second aerated zone 319b downstream of the second unaerated zone 317b. In a third pass 310, the multi-pass flow through reactor 304 of the system 302 also includes an adsorption zone 312c, a first unaerated zone 314c downstream of the adsorption zone 312c, a first aerated zone 316c downstream of the first unaerated zone 314c, a second unaerated zone 317c downstream of the first aerated zone 316c, and a second aerated zone 319c downstream of the second unaerated zone 317c.

At least the adsorption zone 312a of the first pass 306, of the multi-pass flow through reactor 304 of the system 302, can begin operation with AGS granules 318 contained therein. The AGS granules 318 can be returned to at least the adsorption zone 312a of the first pass 306 from a selector zone 324 and exposed to wastewater in a manner that promotes rapid adsorption of pollutants, including nutrients and soluble BOD uptake into the AGS granules 318. A mixing device 330 can be turned on or off to suspend the AGS granules 318 in the wastewater or settle the granules at the bottom of each adsorption zone 312a-c of the multi-pass flow through reactor 304 for improved adsorption. Wastewater having a high pollutant, nutrient, and/or BOD content can be introduced into the adsorption zone 312a of the first pass 306 through a wastewater distribution system 320. The wastewater distribution system 320 may include an inlet pipe, a piping distribution network, an underdrain system at the bottom of the adsorption zone, a step feed channel 322, or other wastewater feed apparatuses or methods that promote rapid pollutant adsorption into the AGS granules 318. As the wastewater comes into contact with the AGS granules 318, pollutants are adsorbed into the AGS granules 318. This represents the “feast” stage of the required “feast and famine” cycle referenced above. Once pollutants are adsorbed, pollutants penetrate through the AGS granules 318 where they are converted and used by the biomass in the different layers of the AGS granules 318. Each layer of the AGS granules 318 can change the character of the nutrients and make the nutrients usable as a substrate for the next layer of biomass that is deeper in the AGS granules 318. This process continues deeper and deeper into the AGS granules 318, starting with aerobic conditions on the outside of the AGS granules 318 and proceeding into anoxic and then anaerobic conditions as penetration into the AGS granules 318 continues.

The wastewater distribution system 320 can create even distribution of raw wastewater through the settled AGS granules 318. The even distribution of raw wastewater can be accomplished by using an inlet pipe, a piping distribution network, an underdrain system at the bottom of each adsorption zones 312a-c, a step feed channel 322, or other wastewater feed apparatuses or methods. The inlet pipe, piping distribution network, underdrain system at the bottom of each adsorption zone 312, or step feed channel 322 can receive the influent wastewater from a wastewater feed pipe or channel and can create an even distribution of wastewater at the bottom of the reactor evenly distributed across the entire bottom surface of the reactor, thereby creating complete contact of wastewater with the AGS granules 318. In a typical SBR, this adsorption cycle is generally unaerated and the mixing is turned off so that granules are settled to the bottom of the reactor. However, in some non-limiting embodiments or aspects shown in FIG. 2, a mixing device 330 within each adsorption zones 312a-c can be turned off and on periodically. Operating the mixing device 330 during the adsorption period allows the granules and wastewater in each adsorption zone 312a-c to move on to the next reactor zone or pass and subsequently continuously flow through the entire multi-pass flow through reactor 304 of the system 302. Flow of wastewater and granules between zones can occur when, for example, the wastewater and granules flow underneath, around, or over the top of the baffle walls 328 separating each zone, or through openings in the baffle walls 328.

As mentioned above, some non-limiting embodiments or aspects of the multi-pass flow through reactor 304 of the system 302 shown in FIG. 2 are intended to provide the required physical and environmental conditions for development and maintenance of AGS granules 318 similar to the cycles of an SBR. The first pass 306 is followed by a second pass 308 located downstream of the first pass 306. A third pass 310 is located downstream of the second pass 308. Subsequent passes may also be included. FIG. 2 depicts the passes as being disposed in parallel with one another since this configuration is more compact and consistent with the layout of conventional or BNR activated sludge aeration basin reactors which can be retrofit with the system of the present disclosure. However, the passes can be positioned in other configurations as well (e.g., the end of the first pass abuts the beginning of the second pass). Each of the first pass 306, the second pass 308, and the third pass 310 can include an adsorption zone 312a-c, a first unaerated zone 314a-c downstream of the adsorption zone 312a-c, a first aerated zone 316a-c downstream of the first unaerated zone 314a-c, a second unaerated zone 317a-c downstream of the first aerated zone 316a-c, and a second aerated zone 319a-c downstream of the second unaerated zone 317a-c. While each “pass” is generally considered to include a set of zones including at least one adsorption zone, at least one aerated zone, and at least one unaerated zone, in some non-limiting embodiments, the second, third, and/or subsequent pass(es) may not include an adsorption zone.

Each unaerated zone 314a-c, 317a-c can be under anaerobic, anoxic, or both anaerobic and anoxic conditions. Each aerated zone 316a-c, 319a-c can be under aerobic conditions. The sequence of each pass can include an adsorption zone 312a-c, a first unaerated zone 314a-c downstream of the adsorption zone 312a-c, a first aerated zone 316a-c downstream of the first unaerated zone 314a-c, a second unaerated zone 317a-c downstream of the first aerated zone 316a-c, and a second aerated zone 319a-c downstream of the second unaerated zone 317a-c, and this sequence can act to deplete the substrate creating the “famine” stage of the “feast and famine” cycle referenced above. The sizes of each zone can be modified and refined to allow for appropriate cycle times under each of the required physical and environmental conditions. For example, the aerated zones 316a-c and 319a-c of each pass can be larger to create a longer aerated cycle time to ensure that the remaining substrate is used by the bacteria causing the bacteria to enter the “famine” stage due to the absence of remaining substrate to consume. Causing the bacteria to enter the “famine” stage helps promote AGS granules 318 with specialized layers of bacteria. In addition, while FIG. 2 illustrates each pass with one aerated zone and one unaerated zone, each pass may contain more than one aerated zone and more than one unaerated zone, such as two of each zone, three of each zone, four of each zone, or more than four of each zone, where the unaerated and aerated zones may alternate. The number of aerated and unaerated zones does not need to be the same within each pass or across different passes. For example, the first pass may include two aerated zones and one unaerated zones while the second pass can include one aerated zone and two unaerated zones.

As mentioned above, the adsorption zone 312a-c of each pass can be outfitted with a mixing device 330. The type of mixing device 330 is not limited to any particular embodiments or aspects. Possible mixing device 330 configurations include mechanical bladed mixers, impellor mixers, hydraulic mixers, large bubble mixers, or any other form of mixer that is typically used for mixing of zones in a BNR aeration basin. The unaerated zones 314a-c, 317a-c of each pass can also include a mixing device 330, and each mixing device 330 could be operated in an on/off cycle or could run continuously. Each mixing device 330 can suspend the AGS granules 318 within the wastewater so the AGS granules 318 can flow to the next zone and can create an up and down movement within the water column of the zone wherein the AGS granules 318 can attract and retain floe and build the dense and highly spherical shape.

The multi-pass flow through reactor 304 of the system 302 can include aerated zones 316a-c, 319a-c in each pass. Each aerated zone 316a-c, 319a-c can be configured like standard aerobic zones that would be found in any activated sludge or biological nutrient removal (BNR) system. Each aerated zone 316a-c, 319a-c can use any known type of aeration device 332 commonly used in those systems, including, for example, a sparger aerator, a coarse bubble aeration system, a fine bubble aeration system, or a surface aeration system. Each aeration device 332 or feed valve to aeration grids may be capable of cycling on and off or it may run continuously. There may be a benefit in cycling the air on and off to create additional transient anoxia conditions.

The multi-pass flow through reactor 304 of the system 302 can include a selector zone 324, which could use high-rate heavy solids removal and/or high rate clarification (such as through the use of HeadCells), or other grit removal system(s), positioned downstream of the second aerated zone 319c of the third pass 310 (or another pass if more than three passes are included) that can allow heavy particles to settle out and lighter particles to continue on downstream either to an existing or new clarifier (e.g., circular, rectangular, high rate, or other type of clarifier) or filtration system (e.g., cloth filter, multimedia filter, membrane, or other type of filter). Other grit removal systems include stacked tray grit removal systems, aerated grit removal units, vortex type grit removal units, plate or tube settler solids removal units, or cyclone type grit removal units. In some non-limiting embodiments or aspects, heavier granules can be recovered and passed through a return AGS pumping system 326, where they can be added back into the adsorption zone 312a-c of the first pass 306, the second pass 308, and/or the third pass 310. AGS granules 318 can be returned to one or more of the adsorption zones 312a-c by, for example, dispensing the AGS granules 318 into the wastewater stream that is fed into adsorption zones 312a-c (such as the adsorption zone of the first pass 312a) or AGS granules 318 can be returned to the adsorption zones 312a-c by feeding AGS granules 318 from the return AGS pumping system 326 directly into the adsorption zones 312a-c. The granule selection and recovery process can involve, allowing the heavier granules to drop onto trays, transferring them to a center column, and then pumping them out of the underflow portion of the center column through the return AGS pumping system 326. The selector zone 324 can be configured to allow lighter biomass floc to pass through the selector zone 324 and out of the flow through reactor 304 in a treated wastewater stream 340 to existing or new downstream liquids/solids separation processes such as conventional secondary or final clarifiers, high rate clarifiers, grit removal technologies, filtration systems including, for example, media filtration, cloth filtration, or membrane filtration. Alternatively, the selector zone 324 can separate lighter biomass floc from the liquid phase so that treated wastewater stream 340 contains only limited amounts of the lighter biomass floc.

The multi-pass flow through reactor 304 of the system 302 can include baffle walls separating each zone and/or each pass. The baffle walls 328 can be constructed of any suitable material and are commonly concrete, wood, fiberglass, steel, or fabric curtains, etc. In addition, alternating aerated and unaerated zones can also be created without hard baffle walls by alternating zones with aeration grids and without aeration grids, or by turning aeration on and off in alternating aeration grids within a single zone. In FIG. 2, the multi-pass flow through reactor 304 of the system 302 includes baffle walls 328 separating each zone of each pass. The number, placement, and orientation of the baffle walls 328 are not limited to those shown in some non-limiting embodiments or aspects and fewer or more baffle walls could be utilized in the multi-pass flow through reactor 304 of the system 302. The addition of baffle walls 328 in a particular pass could allow for more zones to provide additional aerated and unaerated sequences.

With continued reference to FIG. 2, each adsorption zone 312a-c of each pass can repeat the process described above of receiving a raw wastewater feed and distributing that wastewater feed evenly throughout the adsorption zone. In some non-limiting embodiments or aspects, wastewater can enter the adsorption zone 312a-c without the aid of a bottom flow distribution network. In some non-limiting embodiments or aspects, a step feed channel 322, or some other piping configuration, can be used to feed raw wastewater into the adsorption zones 312b and 312c of the second pass 308 and the third pass 310, respectively. In addition to this raw wastewater feed, the adsorption zone 312b of the second pass 308 also receives the “famine” granules and wastewater that exit the first pass 306. Like in the adsorption zone 312a of the first pass 306, the AGS granules 318 that enter the adsorption zone 312b of the second pass 308 can settle to the bottom of the zone and rapidly adsorb pollutants, nutrients, and soluble BOD in the wastewater. Similarly, the adsorption zone 312c of the third pass 310 can receive a raw wastewater feed along with the “famine” AGS granules 318 and wastewater exiting the second pass 308. Within the adsorption zone 312c of third pass 310, these AGS granules 318 can settle to the bottom of the zone and rapidly adsorb nutrients in the raw wastewater. Multiple adsorption zones 312a-c can help maintain the growth and continued development of the AGS granules 318 by providing multiple “feast and famine” cycles within the multi-pass flow through reactor 304.

The multi-pass flow through reactor 304 of the system 302 can include a step feed channel 322, or some other piping configuration, to feed raw wastewater into the adsorption zone 312b and 312c of the second pass 308 and the third pass 310, as well as any subsequent passes. The step feed channel 322 can include a step feed operation in which the amount or ratio of raw wastewater fed into each adsorption zone is variable and optimized. The step feed operation can include an appropriate amount of wastewater fed into the adsorption zone 312b of the second pass 308 relative to the amount of wastewater fed to the adsorption zone 312a of the first pass 306, and a subsequent amount of wastewater fed into the adsorption zone 312c of the third pass 310 relative to the wastewater fed to the adsorption zone 312b of the second pass 308. For example, the first pass 306 can be provided with the highest amount of raw wastewater since raw wastewater entering the first pass 306 will have the longest contact time with the AGS granules 318, thus a higher amount of pollutant removal. To vary the loads to each adsorption zone 312a-c based on contact time, in this example, the amount of influent wastewater is reduced in each subsequent pass.

The wastewater in the systems as described in FIGS. 1 and 2 can be treated with a ballast material at various points. A ballast material is any material that is generated in or added to the wastewater for the purpose of improving liquids/solids separation and settling. The ballast material can be, for example, an artificial ballast, which is a ballast material added to the mixed liquor that does not occur naturally in wastewater, such as but not limited to sand, iron or iron derivatives, or synthetic fabricated materials and shapes, etc. The ballast material may also be a natural ballast, which is a naturally occurring ballast material within the wastewater or generated in the process of liquid or solid treatment applied to the mixed liquor to aid in liquids/solids separation and settling.

Ballast material can be added to the influent wastewater stream. The ballast material can also, or alternatively, be added to the wastewater in any of the zones as described above in FIGS. 1 and 2 directly through a ballast material supply unit (in the form of, e.g., a ballast supply tank in combination with a metering pump) that is in communication with one or more of the zones. Ballast material can also, or alternatively, be added to the RAS, the IR, or other locations that flow to the zones in amounts prescribed by the particular type of ballast being used. In non-limiting embodiments or aspects, ballast material can be recovered in a selector zone and reintroduced in any of the zones as described above in FIGS. 1 and 2.

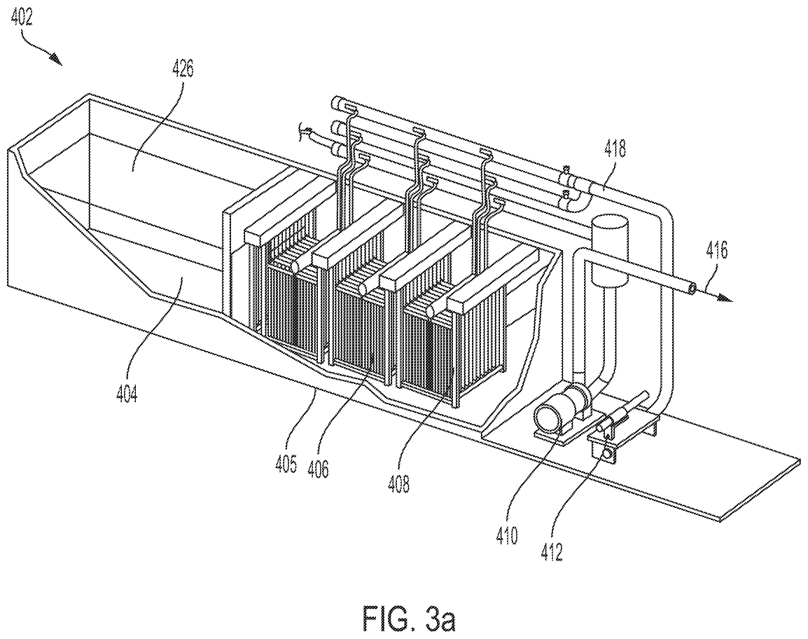

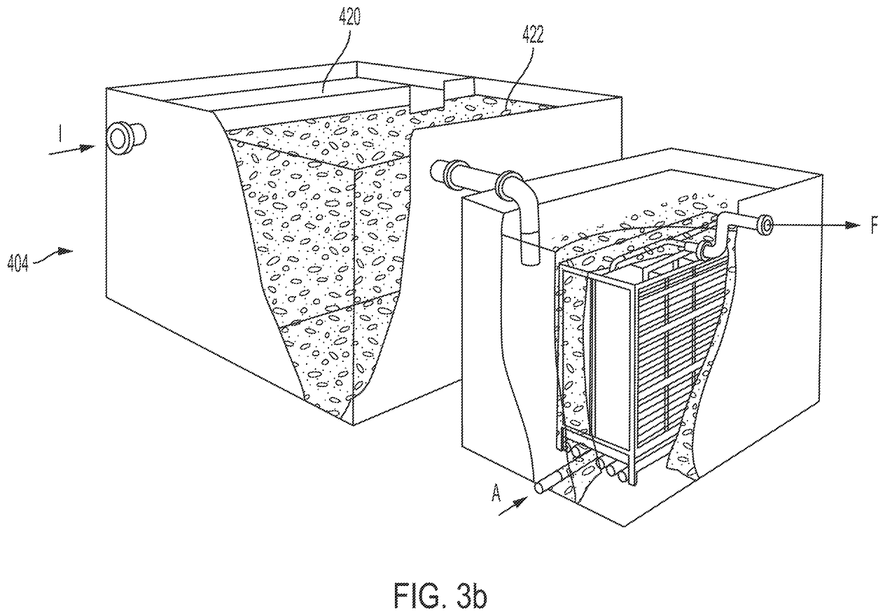

With reference to FIG. 3a, an immersed membrane bio-reactor (MBR) system 402 is shown. In non-limiting embodiments or aspects, the MBR system 402 includes a bio-reactor 404. Referring to FIG. 3b, the wastewater in the bio-reactor 404 can be treated in an anoxic zone 420 and aerobic zone 422. In non-limiting embodiments or aspects, the wastewater is introduced into the anoxic zone 420, and then introduced into the aerobic zone 422. In another embodiment, the anoxic zone 420 is downstream of the aerobic zone 422. In non-limiting embodiments or aspects, the bio-reactor 404 consists of two anoxic and aerobic zones, three anoxic and aerobic zones, four anoxic and aerobic zones, or more than four anoxic and aerobic zones.

With further reference to FIG. 3a, downstream of the bio-reactor 404 is an immersed membrane unit 405. After wastewater 426 is treated in the bio-reactor 404, the wastewater 426 is introduced into the immersed membrane unit 405 which includes one or more membranes 406 in a membrane tank. The immersed membrane unit 405 further treats the wastewater through at least the filtering of the wastewater by the immersed membranes 406. The one or more membranes 406 may be placed in a frame 408 that is configured to hold the membranes 406. In non-limiting embodiments or aspects, the MBR system 402 has a suction pump 410 that creates a negative pressure within the piping 418 that is in communication with the membranes 406. The negative pressure caused by the suction pump 410 facilitates the movement of the wastewater 426 into the membranes 406 and out of the membranes 406 into the direction (F) as shown in FIG. 3b. The suction pump 410 also facilitates the movement of treated wastewater from the MBR system 402 as indicated by the arrow 416 in FIG. 3a. In non-limiting embodiments or aspects, the MBR system 402 has a blower 412. The blower 412 introduces air into the immersed membrane unit 405, for example below the membranes 406 in the direction A as shown in FIG. 3b. The air introduced by the blower 412 removes waste from the membranes 406.

The SBR or flow through AGS process described above, such as that described with reference to FIGS. 1 and 2, can be combined with aspects of an immersed membrane bio-reactor (MBR) system, such as that described with reference to FIGS. 3a and 3b. The AGS mixed liquor obtained from the SBR or flow through AGS process can be transferred from the AGS reactor to the immersed membrane unit 405. The membrane unit 405 receiving AGS mixed liquor can be subject to continuous or intermittent (pulsed) mixing using aeration for membrane air scour. As described further below, the AGS mixed liquor may be clarified before being transferred to the membrane unit 405, such as through a settled fill/draw cycle in an SBR or through pre-clarification or selector in a flow through AGS format. FIGS. 3a and 3b depict various non-limiting examples of MBR configurations. In these examples, the bio-reactor 404 could be the SBR AGS reactor or flow through AGS reactors described above. Other examples of MBR systems that include immersed membranes that may be useful in connection with the AGS/MBR system of the present disclosure include those described in, for instance, U.S. Pat. No. 8,017,014, assigned to Ecolab USA, U.S. Pat. No. 10,099,951, assigned to Liberty Evans LLC, and United States Patent Application Publication No. 2010/0264080, assigned to Ovivo Inc., the disclosure of each of which is expressly incorporated herein by reference in its entirety. Other membrane suppliers include, for example, Suez, Dupont, Evoqua-Zenon, Kubota, and Koch.

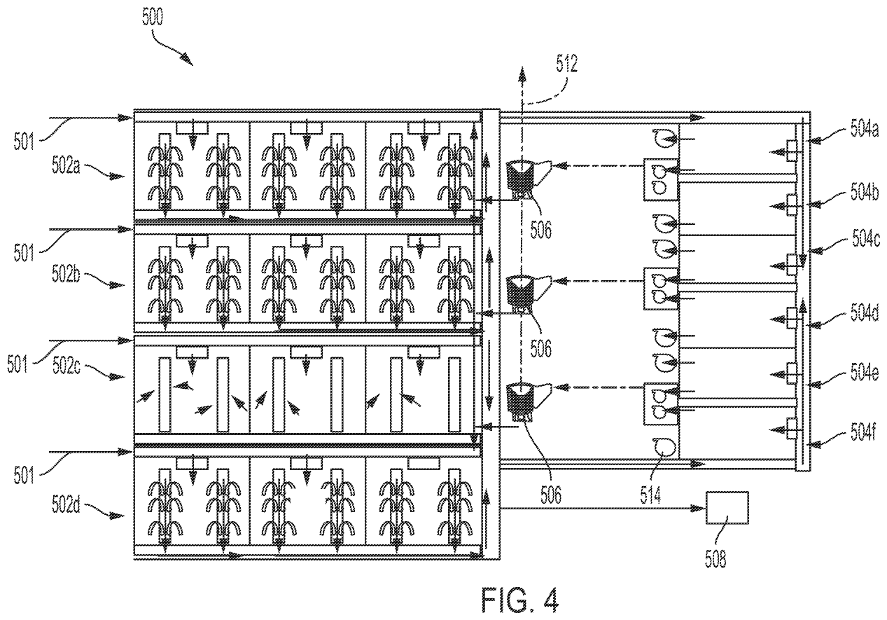

With reference to FIG. 4, provided is one embodiment of a system 500 incorporating MBR technology into an AGS process using a SBR. In FIG. 4, four AGS reactors 502a-d are depicted in parallel, though fewer or more reactors can be used depending on the overall size and capacity of the system 500. In non-limiting embodiments or aspects, the AGS reactors 502a-d are in different stages of the fill/aerate/settle cycle described above. In particular, the topmost and bottommost AGS reactors 502a and 502d are depicted in the fill/draw stage, the second reactor 502b (from the top) is depicted in the aerate stage, and the third reactor 502c (from the top) is depicted in the settle stage, thereby illustrating that the parallel reactors may (or may not) operate independently and on different cycle times. Other known combinations of typical SBR sequences for AGS, which would be known to a person of skill in the art, are also included by reference.

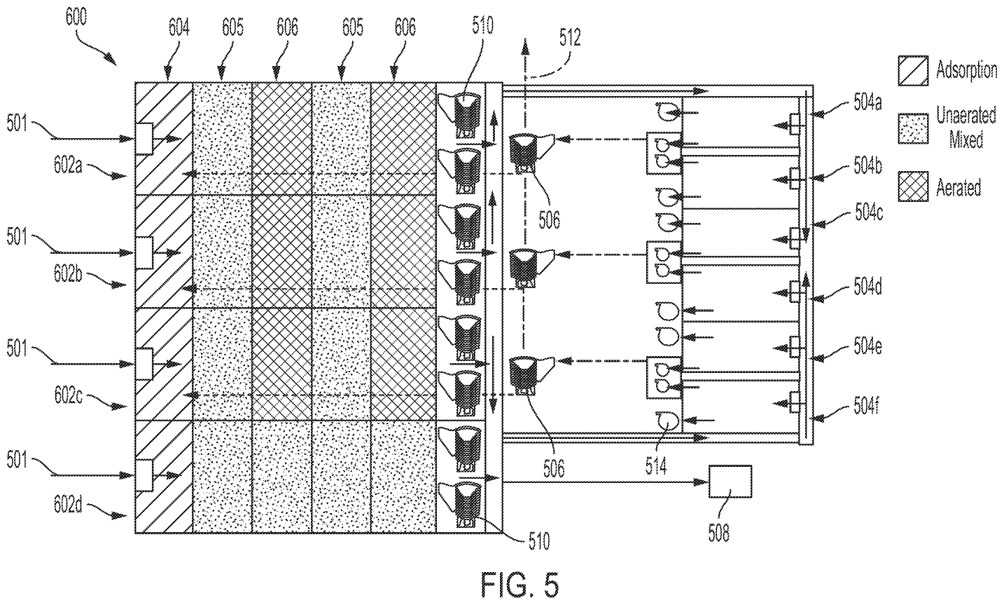

In FIG. 4, primary effluent (PE) or raw wastewater (Raw WW) 501 can be fed to each AGS reactor 502a-d. Each AGS reactor 502a-d may include AGS granules and a mix of treated and untreated wastewater. The PE or Raw WW 501 can be introduced during the fill/draw cycle through a bed of settled AGS granules and subject to a period of rapid adsorption of pollutant to the granules. Each AGS reactor 502a-d can then cycle through aerate and settle sequences. In one operational configuration, the AGS mixed liquor can be discharged from the AGS reactor during the aerate cycle and transferred to one or more of the MBR units 504a-f, such as a respective MBR unit (e.g., AGS reactor 502a discharges AGS mixed liquor to MBR unit 504a). Each MBR unit 504a-f can contain one or more immersed membranes contained with a tank, for example, as depicted in the immersed membrane unit 405 of FIGS. 3a and 3b. In another operational configuration, the treated effluent can be discharged from one or more of the AGS reactors 502a-d during the fill/draw cycle and transferred to one or more MBR units 504a-f. A combination of both AGS mixed liquor from the aerate cycle and clear effluent from the fill/draw cycle can also be transferred to the MBR unit 504a-f. FIG. 4 illustrates six parallel MBR units 504a-f each with multiple MBR cartridges or modules. However, the number and arrangement of MBR units 504a-f and cartridges/modules can be varied depending on the overall size and capacity of the system. The mixed liquor or clear effluent transferred to the MBR units 504a-f may or may not include the AGS granules. For example, the AGS mixed liquor may be clarified before being transferred to the MBR units 504a-f, such as through a settled fill/draw cycle or through a selector/clarifier 510 (see FIG. 5) positioned between the AGS reactor 502a-d and the MBR unit 504a-f, so as to remove the heavier AGS granules and retain them within the AGS reactor 502a-d.

Upon receiving the mixed liquor, the MBR unit 504a-f can then filter the mixed liquor and produce a clarified permeate 514. A portion of the mixed liquor can be returned as return activated sludge (RAS) to the AGS reactors 502a-d and passed through a RAS selector 506 so as to remove the heavier AGS granules and retain them within the AGS reactors 502a-d. In non-limiting embodiments or aspects, the RAS may be transferred to the RAS selector 506 by a pump, such as an air lift pump. Preferred RAS pumping equipment can provide gentle pumping action so as not to disintegrate the AGS granules retained within the mixed liquor. While an air lift RAS pump is one such example, other exemplary pumps would be known to a person of skill in the art upon reading the present disclosure.

As mentioned, and with reference to FIG. 5, the RAS mixed liquor can be passed through a selector/clarifier 510. Some non-limiting embodiments or aspects of the selector/clarifier 510 incorporate any process normally associated with removal of heavy material, including sand and grit from wastewater. Some non-limiting embodiments or aspects of grit removal technology include a stacked tray grit removal system known as a HeadCell. The selector/clarifier 510 separates and retains the AGS granules and allows light floc material that has not been absorbed into a granule to be wasted from the system, depicted as suspended floc or waste activated sludge 512 (WAS) in FIG. 4. Through this separation process, the selector/clarifier can concentrate and select for heavy granules to return to the SBR. Other non-limiting grit removal technologies that can serve as a selector/clarifier include, for example, aerated grit removal units, vortex type grit removal units, plate or tube settler type solids removal units, and cyclone type grit removal units. Available removal systems include those described in PCT Publication No. WO 2019/046416, filed Aug. 29, 2018 and entitled “Ballasted Activated Sludge Treatment Combined with High-Rate Liquids/Solids Separation Systems,” the contents of which are herein incorporated by reference in their entirety.

With continued reference to FIG. 4, the bottommost depicted AGS reactor 502d is configured to either feed effluent or AGS mixed liquor to a MBR unit 504a-f or to a wet weather or excess flow unit 508. The wet weather or excess flow unit 508 is adapted to receive PE or Raw WW 501 in situations of excess flow, such as can occur in wet weather. In some non-limiting embodiments or aspects, the excess flow unit can treat the PE or Raw WW 501 through contact stabilization with AGS under a fill/draw sequence and then pass the clear supernatant to a wet weather discharge (outfall) rather than to an MBR tank/zone.

With reference to FIG. 5, provided is non-limiting embodiments or aspects of a system 600 incorporating MBR technology into an AGS process using a flow through AGS reactor. FIG. 5 depicts four flow through AGS reactors 602a-d in parallel, though the number of reactors can be more or less depending on the overall size and capacity of the system. Each AGS flow through reactor 602a-d can be configured like the reactors described above in connection with FIGS. 1 and 2. With specific reference to FIG. 5, each AGS reactor 602a-d includes an adsorption zone 604 (first zone in each), followed by at least one unaerated mixed zone 605 (second and fourth zones in first three reactors; second through fifth zones in last reactor), and at least one aerated zone 606 (third and fifth zones in first three reactors). While not shown in FIG. 5, each adsorption zone could include a mixer and each aerated zone could include aeration diffusers, as described above for FIGS. 1 and 2.

Each flow through AGS reactor 602a-d receives PE or Raw WW 501 influent where the influent can be mixed with AGS granules in the adsorption zone 604. The mixed liquor (including granules) then passes through the various stages of the reactor. In FIG. 5, the AGS mixed liquor discharged from the each flow-through AGS reactor 602a-d is passed through a selector/clarifier 510 which acts to retain and return the heavy granules to the adsorption zone 604 while allowing light floc 512 to continue to the MBR. The selector/clarifier 510 can be of the types describe above with respect to FIG. 4. Removal of the heavy granules prior to the MBR units 504a-f can provide certain benefits, including a higher flux rate at the MBR units 504a-f, reduced air scour for cleaning, reduced periodic chemical frequency and durations, reduced RAS rates, and improved membrane integrity due to a more clarified effluent.

FIG. 5 illustrates six parallel MBR units 504a-f. However, like with the AGS embodiments discussed above, the number and arrangement of MBR units 504a-f can be more or less depending on the overall size and capacity of the system. The MBR units 504a-f can filter the mixed liquor and produce a clarified permeate 514. A portion of the mixed liquor can be returned as RAS through a RAS selector 506. In non-limiting embodiments or aspects, a pump, such as an air lift pump, transfers RAS to the RAS selector 506. As discussed with respect to FIG. 4 above, the RAS selector 506 in FIG. 5 separates and retains heavy granules and allows light floc material to be wasted from the system, depicted as suspended floc 512 in FIG. 5. Through this separation process, the system can retain and concentrate heavy granules for return to the flow through AGS reactors 602a-d, and particularly the adsorption zone.

Similarly, the bottommost depicted AGS reactor 602d in FIG. 5 is configured to serve either to feed effluent or AGS mixed liquor to the MBR unit 504a-f or to a wet weather or excess flow unit 508, which is adapted to receive PE or Raw WW 501 in situations of excess flow, such as in wet weather conditions. In some non-limiting embodiments or aspects, the wet weather or excess flow unit 508 can treat the PE or Raw WW 501 through contact stabilization with AGS under a fill/draw sequence and then pass the clear supernatant to a wet weather discharge (outfall) rather than to an MBR tank.

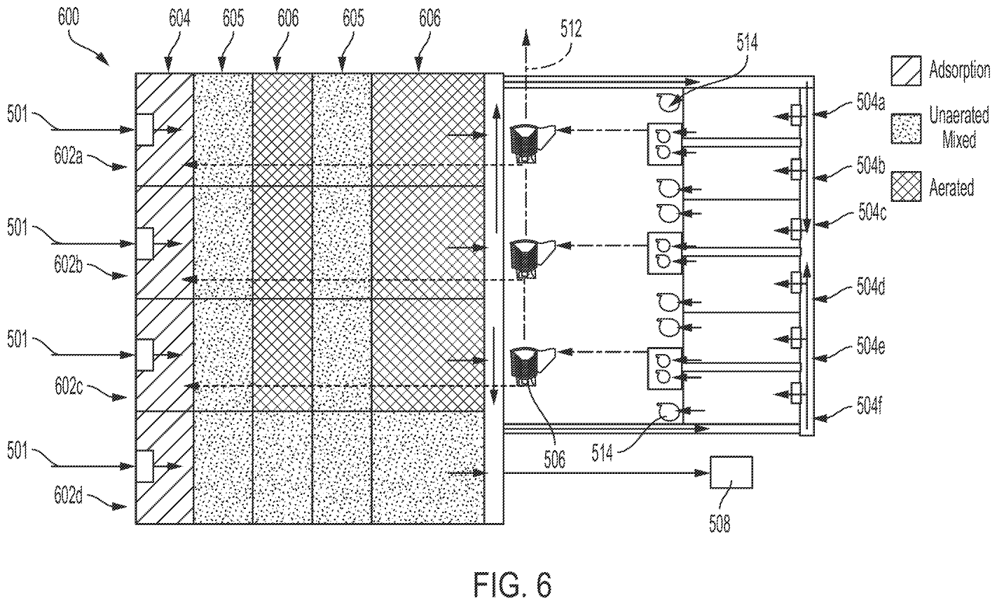

With reference to FIG. 6, provided are non-limiting embodiments or aspects of a system 600 incorporating MBR technology into an AGS process using a flow through AGS reactor. FIG. 6 can include the same components and process as FIG. 5, though FIG. 6 does not include a selector/clarifier 510 between the flow through AGS reactors 602a-d and the MBR units 504a-f. Thus, the mixed liquor arriving at the MBR units 504a-f can include the AGS granules, similar to one operational mode of the SBR configuration of FIG. 4.

When an unclarified AGS mixed liquor is passed to the MBR units, following an AGS process (e.g., FIGS. 4 and 6), certain membrane process advantages may be exhibited as compared to immersed membrane liquids/solids separation in a conventional MBR dispersed biomass floc.

For example, an increase in membrane flux associated with increased clear water surrounding the dense granules in an AGS mixed liquor may occur. In addition to more free water in an AGS mixed liquor, the highly spherical nature of the AGS granules can reduce potential agglomeration on the membrane surface and thereby reduces membrane bio-fouling potential and are more readily scoured from the membrane surface with reduced scour air quantities.

There may also be a reduced production and external secretion of exopolymeric substances (EPS) from the AGS biomass as compared to conventional dispersed floc, thereby reducing the potential for EPS fouling of the membrane.

In addition, higher membrane flux rates with immersed membranes operating in an AGS mixed liquor as compared to a conventional MBR, dispersed floc mixed liquor will reduce the capital cost of the system. A reduction in trans-membrane operating pressures associated with increased clear water, reduced bio-fouling, and reduced EPS secretion along with other properties of an AGS system may also occur. A reduction in trans-membrane pressure will reduce the permeate withdrawal systems power and operating cost as compared to a conventional dispersed floc MBR process.

A reduction in scour air requirements due to the dense granule, spherical shape, higher percentage of clear water, reduction in EPS secretion and other characteristics of AGS may occur. A reduction in scour air requirements will reduce the power and operating cost as compared to a conventional dispersed floc MBR process.

One may also experience a reduction in membrane cleaning frequency and chemical use associated with increased clear water, reduced bio-fouling, reduced EPS secretion, and increased flux rates along with other properties of an AGS system. A reduction in membrane cleaning frequency will result in greater reliability, treatment system up-time, reduction in redundant membranes and associated reduction in operating and maintenance costs. A reduction in membrane cleaning chemical use will result in reduced operating and maintenance costs and provide a longer life cycle to replacement.

The system described may increase membrane integrity and improve the confidence for IPR and DPR reuse, in which log removal credits through the membrane could be increased to the credits typically achieved in tertiary (clear effluent) membrane applications.

AGS mixed liquor applied to MBR systems may reduce RAS rates creating a more cost effective treatment system to construct and to operate and maintain. When a clarified AGS effluent is passed to the membrane liquids/solids separation tank following an AGS process (e.g., FIG. 5), certain membrane process advantages may be exhibited as compared to immersed membrane liquids/solids separation in a conventional MBR dispersed biomass floc. For example, in this format, the immersed membrane provides additional liquids/solids separation of light floc not associated with granules that occurs in typical SBR or flow through AGS systems. In many cases the SBR tanks must be oversized to allow separation of dispersed floc, or further downstream treatment using clarifiers, high rate settling, filtration or other solids removal processes.

Although the present disclosure has been described in detail in connection with the above embodiments and/or examples, it should be understood that such detail is illustrative and not restrictive, and that those skilled in the art can make variations without departing from the disclosure.

1. A wastewater treatment system, comprising:
a flow through activated granular sludge (AGS) reactor, comprising:
a first adsorption zone that receives a wastewater input and AGS granules;
a first unaerated zone, wherein the first unaerated zone is downstream of the first adsorption zone, wherein the first unaerated zone is under anaerobic, anoxic, or both anaerobic and anoxic conditions;
a first aerated zone, wherein the first aerated zone is downstream of the first unaerated zone, wherein the first aerated zone is under aerobic conditions;
a second unaerated zone, wherein the second unaerated zone is downstream of the first aerated zone, wherein the second unaerated zone is under anaerobic, anoxic, or both anaerobic and anoxic conditions; and
a second aerated zone, wherein the second aerated zone is downstream of the second unaerated zone,
wherein the flow through AGS reactor produces and discharges an AGS mixed liquor; and
a membrane bio-reactor unit downstream of the flow through AGS reactor that receives the AGS mixed liquor discharged from the flow through AGS reactor, the membrane bio-reactor unit comprising one or more immersed membranes within a membrane tank, wherein the membrane bio-reactor unit filters the AGS mixed liquor and produces a clarified permeate.

2. The wastewater treatment system of claim 1, wherein the AGS granules are introduced to the wastewater in the first adsorption zone.

3. The wastewater treatment system of claim 1, further comprising at least one mixing device within at least one of the unaerated zones of the flow through AGS reactor, wherein the at least one mixing device can be turned on or off.

4. The wastewater treatment system of claim 1, further comprising at least one aeration device within at least one of the aerated zones of the flow through AGS reactor.

5. The wastewater treatment system of claim 1, wherein a ballast material is introduced to the wastewater in the first adsorption zone.

6. The wastewater treatment system of claim 5, wherein the AGS granules comprise the ballast material.

7. The wastewater treatment system of claim 1, further comprising a selector zone, wherein the selector zone is downstream of the flow through AGS reactor and upstream of the membrane bio-reactor unit, and wherein the selector zone separates the AGS granules and/or ballast material from the AGS mixed liquor.

8. The wastewater treatment system of claim 7, wherein separated granules and/or ballast material are reintroduced in the first adsorption zone of the flow through AGS reactor.

9. The wastewater treatment system of claim 1, further comprising an excess flow unit, wherein the excess flow unit is downstream of the flow through AGS reactor and separate from the membrane bio-reactor unit, and wherein a portion of the wastewater flows to the excess flow unit.

10. The wastewater treatment system of claim 1, further comprising two or more flow through AGS reactors operating in parallel.

11. The wastewater treatment system of claim 1, wherein the flow through AGS reactor is a multi-pass flow through reactor.

12. The wastewater treatment system of claim 1, wherein the membrane bio-reactor unit comprises an aeration system.

13. The wastewater treatment system of claim 1, further comprising two or more membrane bio-reactor units operating in parallel.

14. The wastewater treatment system of claim 1, further comprising at least one return activated sludge selector unit downstream of the membrane bio-reactor unit, wherein the at least one return activated sludge selector unit is adapted to separate the AGS granules and/or ballast material from a discharge of the membrane bio-reactor unit.

15. The wastewater treatment system of claim 14, wherein separated granules and/or ballast material from the at least one return activated sludge selector unit is reintroduced to the flow through AGS reactor.

16. A method of treating wastewater in a wastewater treatment system comprising:
treating the wastewater in a flow through activated granular sludge (AGS) reactor, comprising:
(a) introducing the wastewater and AGS granules to an adsorption zone of the flow through AGS reactor;
(b) subsequent to step (a), distributing the wastewater to a first unaerated zone of the flow through AGS reactor, wherein the first unaerated zone is downstream of the adsorption zone, wherein the first unaerated zone is under anaerobic, anoxic, or both anaerobic and anoxic conditions;
(c) subsequent to step (b), distributing the wastewater to a first aerated zone of the flow through AGS reactor, wherein the first aerated zone is downstream of the first unaerated zone, wherein the first aerated zone is under aerobic conditions;
(d) subsequent to step (c), distributing the wastewater to a second unaerated zone of the flow through AGS reactor, wherein the second unaerated zone is downstream of the first aerated zone, wherein the second unaerated zone is under anaerobic, anoxic, or both anaerobic and anoxic conditions; and
(e) subsequent to step (d), distributing the wastewater to a second aerated zone of the flow through AGS reactor, wherein the second aerated zone is downstream of the second unaerated zone, wherein the second aerated zone is under aerated conditions;
(f) outputting from the flow through AGS reactor an AGS mixed liquor; and
treating the AGS mixed liquor in a membrane bio-reactor unit, comprising:
(a) distributing the AGS mixed liquor to the membrane bio-reactor unit, wherein the membrane bio-reactor unit comprises one or more immersed membranes within a membrane tank; and
(b) subsequent to step (a), filtering the AGS mixed liquor in the membrane bio-reactor unit to produce a clarified permeate.

17. The method of claim 16, wherein the AGS granules are introduced to the wastewater in the adsorption zone.

18. The method of claim 16, further comprising mixing the wastewater in the unaerated zones of the flow through AGS reactor.

19. The method of claim 16, further comprising aerating the aerated zones of the flow through reactor.

20. The method of claim 16, further comprising introducing a ballast material to the wastewater in the adsorption zone.

21. The method of claim 16, wherein the AGS granules comprises the ballast material.

22. The method of claim 16, further comprising separating the AGS granules and/or ballast material from the AGS mixed liquor.

23. The method of claim 22, further comprising reintroducing the AGS granules and/or ballast material to the adsorption zone of the flow through AGS reactor.

24. The method of claim 16, further comprising distributing a portion of the wastewater to an excess flow unit.

25. The method of claim 16, wherein the wastewater treatment system comprises two or more flow through AGS reactors operating in parallel, wherein each of the flow through AGS reactors treats the wastewater pursuant to steps (a)-(e) of claim 16 to generate AGS mixed liquor.

26. The method of claim 16, wherein the flow through AGS reactor is a multi-pass AGS flow through reactor.

27. The method of claim 16, further comprising aerating the AGS mixed liquor in the membrane bio-reactor unit.

28. The method of claim 16, wherein the wastewater treatment system comprises two or more membrane bio-reactor units.

29. The method of claim 16, further comprising subjecting an output of the membrane bio-reactor unit to a return activated sludge separation process to recover AGS granules and/or ballast material.

30. The method of claim 29, further comprising introducing the AGS granules and/or ballast material that were recovered in the return activated sludge separation process to the flow through AGS reactor.
